(19) United States
(12) Patent Application Publication
(10) Pub. No.: US 2025/0260289 A1
(43) Pub. Date: Aug. 14, 2025

(54) HIGH-VOLTAGE CONNECTOR FOR THREE-PHASE ELECTRICAL MACHINE

(71) Applicant: Schaeffler Technologies AG & Co. KG, Herzogenaurach (DE)

(72) Inventors: Mauricio Vergara López, San Pedro Cholula (MX); Antonio Cortés Ramírez, Puebla (MX)

(21) Appl. No.: 18/436,788

(22) Filed: Feb. 8, 2024

(51) Int. Cl. H02K 5/22; H01R 43/26

(52) U.S. Cl. CPC H02K 5/225; H01R 43/26

(57) ABSTRACT

An electrical connector may provide a threadless means for joining a junction box with a busbar without requiring tooling, which is desirable for ease-of-assembly when coupling and uncoupling the electrical connector. The junction box and the busbar may include side release buckle geometries which are configured for engagement. The junction box may include plugs with a base, prongs, and conductive lips which define a male portion of the side release buckle geometries. The busbar may include sockets with side portions, through holes, and a center portion which may define a female portion of the side release buckle geometries.

### TECHNICAL FIELD

The present disclosure generally relates to electrical connections between conductive members, and, more particularly, to securing electrical connections.

### BACKGROUND

High-voltage electrical connections are used in several three-phase electric machines. The high-voltage electrical connections in the three-phase electric machines typically use a threaded connection. The threaded connection ensures the connection is maintained when subject to vibrations. However, the threaded connection undesirably requires the use of tooling during assembly and disassembly. Therefore, it would be advantageous to provide a device, system, and method that cures the shortcomings described above.

### SUMMARY

An electrical connector is described, in accordance with one or more embodiments of the present disclosure.

The electrical connector may include a junction box including a plurality of plugs including a base, a first prong, a second prong, a first conductive lip and a second conductive lip. The first prong and the second prong may extend from the base. The first conductive lip may extend from the first prong. The second conductive lip may extend from the second prong. The first prong and the second prong may be disposed between the first conductive lip and the second conductive lip. The electrical connector may include a busbar including a plurality of sockets including a center portion, a first side portion, and a second side portion. The center portion may be disposed between the first side portion and the second side portion. The first side portion and the center portion may define a first through hole. The second side portion and the center portion may define a second through hole. The plurality of plugs may be connected to the plurality of sockets. The first prong may be disposed in the first through hole and the second prong is disposed in the second through hole. The first conductive lip may abut the first side portion and the second conductive lip abuts the second side portion.

An electric motor is described, in accordance with one or more embodiments of the present disclosure. The electric motor may include an electrical connector. The electrical connector may include a junction box including a plurality of plugs including a base, a first prong, a second prong, a first conductive lip and a second conductive lip. The first prong and the second prong may extend from the base. The first conductive lip may extend from the first prong. The second conductive lip may extend from the second prong. The first prong and the second prong may be disposed between the first conductive lip and the second conductive lip. The electrical connector may include a busbar including a plurality of sockets including a center portion, a first side portion, and a second side portion. The center portion may be disposed between the first side portion and the second side portion. The first side portion and the center portion may define a first through hole. The second side portion and the center portion may define a second through hole. The plurality of plugs may be connected to the plurality of sockets. The first prong may be disposed in the first through hole and the second prong is disposed in the second through hole. The first conductive lip may abut the first side portion and the second conductive lip abuts the second side portion. The electric motor may include a stator including a stator core and a winding. The winding may be connected to the busbar. The electric motor may include a rotor.

A method is described, in accordance with one or more embodiments of the present disclosure. The method may include inserting a plurality of plugs of a junction box into a plurality of sockets of a busbar such that the plurality of plugs are connected to the plurality of sockets. The plurality of plugs may include a base, a first prong, a second prong, a first conductive lip and a second conductive lip. The first prong and the second prong may extend from the base. The first conductive lip may extend from the first prong. The second conductive lip may extend from the second prong. The first prong and the second prong may be disposed between the first conductive lip and the second conductive lip. The electrical connector may include a busbar including a plurality of sockets including a center portion, a first side portion, and a second side portion. The center portion may be disposed between the first side portion and the second side portion. The first side portion and the center portion may define a first through hole. The second side portion and the center portion may define a second through hole. The first prong may be disposed in the first through hole and the second prong is disposed in the second through hole. The first conductive lip may abut the first side portion and the second conductive lip abuts the second side portion. The electric motor may include a stator including a stator core and a winding. The winding may be connected to the busbar. The electric motor may include a rotor.

### BRIEF DESCRIPTION OF THE DRAWINGS

The numerous advantages of the disclosure may be better understood by those skilled in the art by reference to the accompanying figures in which:

FIG. 1A illustrates a perspective view of an electrical connection before plugs of a junction box are inserted into sockets of a busbar, in accordance with one or more embodiments of the present disclosure.

FIG. 1B illustrates a partial perspective view of a junction box of an electrical connection, in accordance with one or more embodiments of the present disclosure.

FIG. 1C illustrates a partial perspective view of a busbar of an electrical connection, in accordance with one or more embodiments of the present disclosure.

FIG. 1D illustrates a partial perspective view of an electrical connection with plugs of a junction box inserted into sockets of a busbar such that the plugs and sockets are connected, in accordance with one or more embodiments of the present disclosure.

FIG. 1E illustrates a partial perspective view of an electrical connection with a plug connected to a socket, in accordance with one or more embodiments of the present disclosure.

FIG. 2A illustrates a perspective view of an electric motor, in accordance with one or more embodiments of the present disclosure.

FIG. 2B illustrates a partial perspective view of an electric motor, in accordance with one or more embodiments of the present disclosure.

FIG. 3 depicts a flow diagram of a method of securing an electrical connection, in accordance with one or more embodiments of the present disclosure.

### DETAILED DESCRIPTION OF THE INVENTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

Embodiments of the present disclosure are directed to an electrical connector. The electrical connector may provide a threadless means for joining a junction box with a busbar without requiring tooling, which is desirable for ease-of-assembly when coupling and uncoupling the electrical connector. The junction box and the busbar may include side release buckle geometries which are configured for engagement. The junction box may include plugs with a base, prongs, and conductive lips which define a male portion of the side release buckle geometries. The busbar may include sockets with side portions, through holes, and a center portion which may define a female portion of the side release buckle geometries.

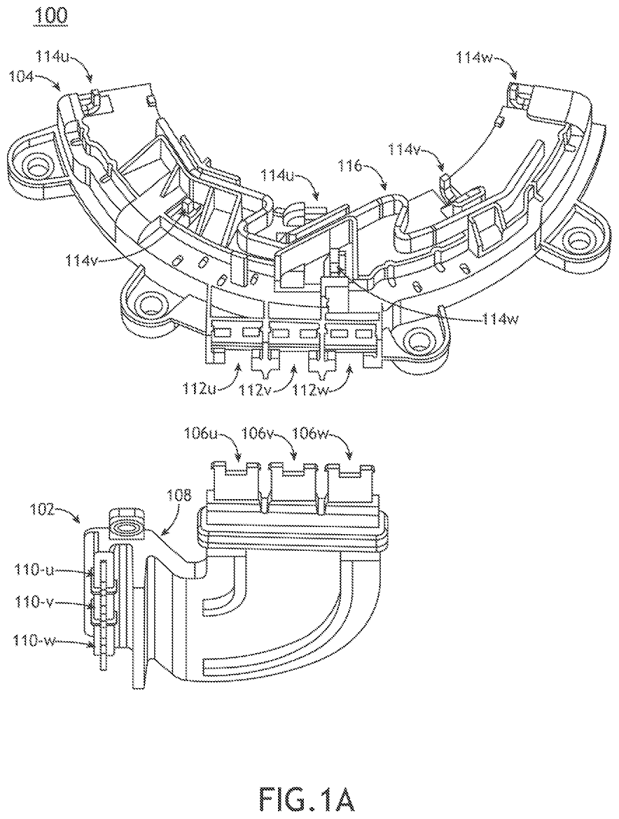

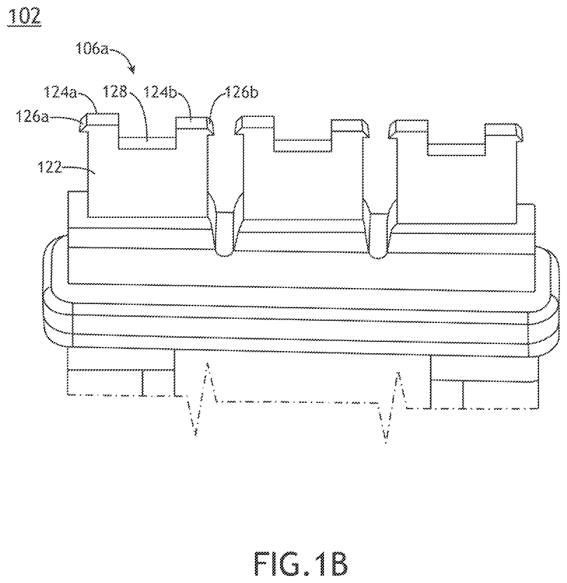

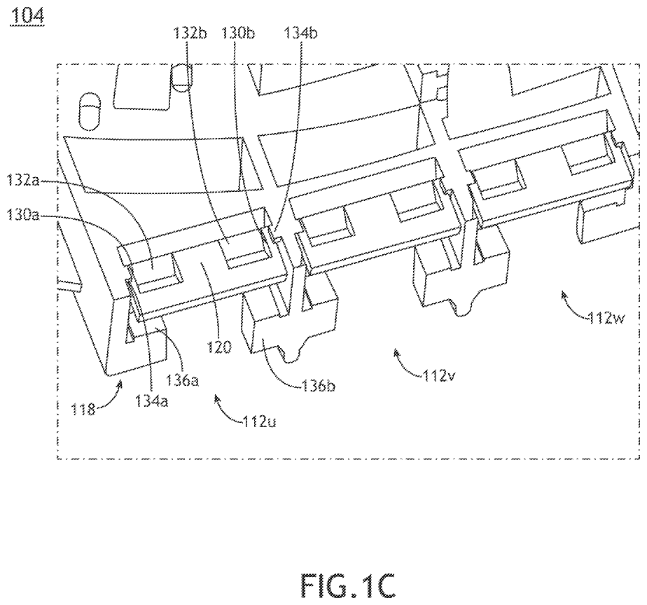

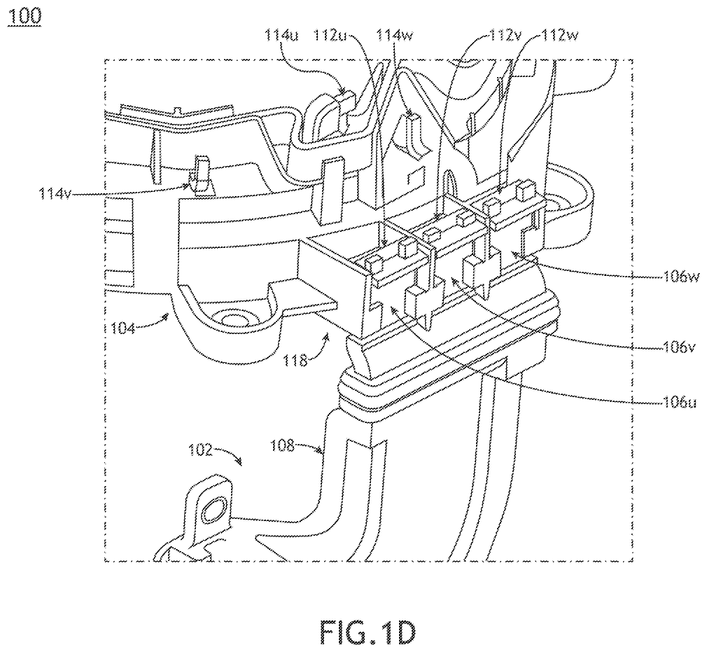

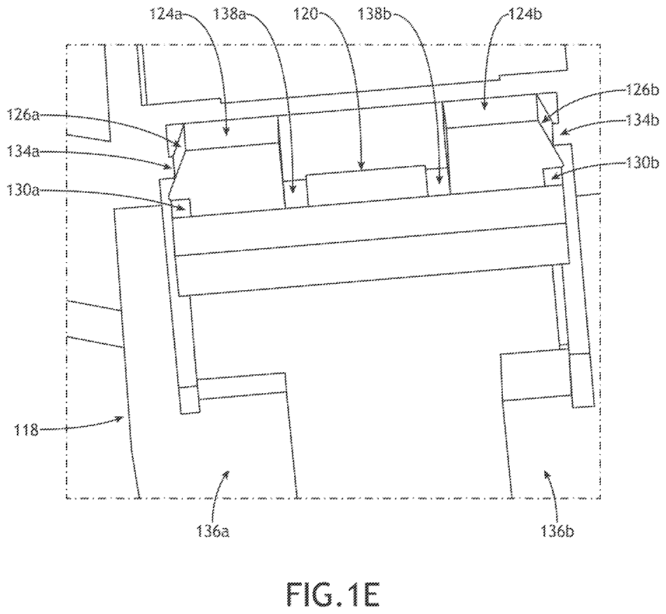

FIGS. 1A-1E illustrate an electrical connector 100, in accordance with one or more embodiments of the present disclosure. The electrical connector 100 may be an electrical connector used in a three-phase electric motor. The electrical connector 100 may include a junction box 102 and/or a busbar 104.

The junction box 102 may receive current from one or more external components. For example, the junction box 102 may receive current from an inverter, controller, or the like. The junction box 102 may receive one or more phases of current. In embodiments, the junction box 102 may receive three phases of current, including first-phase (u), second-phase (v), and third-phase (w). The first-phase (u), the second-phase (v), and the third-phase (w) are generally aligned 120-degrees out of phase. The junction box 102 may include plugs 106, molding 108, and/or bars 110.

The bars 110 may be rigid elements for engagement with one or more external components. The plugs 106 may be rigid elements for engagement with the busbar 104. The junction box 102 may include any number of the plugs 106 and/or bars 110. In embodiments, the junction box 102 may include three of the plugs 106 and three of the bars 110. For example, the junction box 102 may include a first-phase plug 106u, a second-phase plug 106v, a third-phase plug 106w, a first-phase bar 110u, a second-phase bar 110v, and/or a third-phase bar 110w. The plugs 106 and the bars 110 may each carry a respective phase of electricity. For example, the first-phase plug 106u, second-phase plug 106v, and third-phase plug 106w may carry a first-phase, a second-phase, and a third-phase of electricity, respectively. By way of another example, the first-phase bar 110u, second-phase bar 110v, and/or third-phase bar 110w may carry a first-phase, a second-phase, and a third-phase of electricity, respectively. The bars 110 may connect with a respective of the plugs 106 through one or more internal traces within the molding 108.

The plugs 106 may include a base 122, prongs 124, and conductive lips 126. For example, each of the first-phase plug 106u, second-phase plug 106v, and third-phase plug 106w may include the base 122, prongs 124, and conductive lips 126. The plugs 106 may define a male buckle geometry. For example, the plugs 106 may define a male side-release buckle geometry. The base 122, prongs 124, and conductive lips 126 may collectively define the male side-release buckle geometry.

The base 122 may be a flat plate. The base 122 may include a cuboid shape. A thickness of the base 122 may be much less than a length and/or a width of the base 122. The base 122 may extend from the molding 108.

The prongs 124 may be a pair of the prongs 124. For example, the plugs 106 may include a first prong 124a and a second prong 124b. The prongs 124 may extend from the base 122. For example, the prongs 124 may extend from a top edge of the base 122. For instance, the first prong 124a may extend from a first corner of the top edge of the base 122 and the second prong 124b may extend from a second corner of the top edge of the base 122. The prongs 124 may be aligned in parallel. For example, the first prong 124a may be aligned in parallel with the second prong 124b. The prongs 124 may be in a rest position when the prongs 124 are aligned in parallel.

In embodiments, the prongs 124 may have a selected length. For example, the prongs 124 may each have the same length. Although the prongs 124 are described as having the same length, this is not intended as a limitation of the present disclosure. It is further contemplated that the prongs 124 may have differing lengths.

The base 122 and the prongs 124 may define a center notch 128. The center notch 128 may be disposed between the first prong 124a and the second prong 124b. The center notch 128 may include a shape, such as, but not limited to, a square shape, a V-shape, a U-shape, or the like. It is contemplated the base 122 and the prongs 124 may include various geometries such as rounded corner, squared corners, and the like to define the shape of the center notch 128.

In embodiments, the prongs 124 may be a resilient member. In this regard, the prongs 124 may return to an original shape after being deformed. The prongs 124 may have a selected elastic modulus sufficient to allow the prongs 124 to deform and then recover to the original shape. The prongs 124 may be elastically deformed by prongs 124 together. The prongs 124 may be configured to elastically bend inwards from the rest position. For example, the prongs 124 may be pinched together thereby elastically bending the prongs 124 inwards. Bending inwards may refer to bending the prongs 124 towards each other within the center notch 128. For example, the first prong 124a and the second prong 124b may be bent towards each other by a pinching action. The prongs 124 may also be configured to return to the rest position. The return of the prongs 124 may also be referred to as springing backwards. Once the external force is removed, the prongs 124 may expand away from each other due to internal stresses within the prongs 124. Thus, the prongs 124 may be configured to elastically deform from and return to the rest position. The prongs 124 may include a selected elastic modulus to enable bending inwards from and returning to the rest position.

The conductive lips 126 may be wedges or the like. The conductive lips 126 may include a selected shape, such as, but not limited to, a triangular shape. The conductive lips 126 may be a pair of the conductive lips 126. For example, the plugs 106 may include a first conductive lip 126a and a second conductive lip 126b. The conductive lips 126 may extend from the prongs 124. For example, the first conductive lip 126a may extend from the first prong 124a and the second conductive lip 126b may extend from the second prong 124b. The first conductive lip 126a and the second conductive lip 126b may extend from opposing sides of the first prong 124a and the second prong 124b. The first prong 124a and the second prong 124b may be disposed between the first conductive lip 126a and the second conductive lip 126b. In this regard, the prongs 124 may be disposed between the conductive lips 126. In embodiments, the conductive lips 126 may extend from top corners of the prongs 124.

In embodiments, the base 122, prongs 124, and/or conductive lips 126 may be co-planar. For example, the base 122, prongs 124, and/or conductive lips 126 may be disposed in an upright plane. Although the base 122, prongs 124, and/or conductive lips 126 are described as being co-planar, this is not intended as a limitation of the present disclosure. It is further contemplated that the one or more of the base 122, prongs 124, and/or conductive lips 126 may be in offset planes.

In embodiments, each of the plugs 106 may be co-planar. For example, the first-phase plug 106u, the second-phase plug 106v, and/or the third-phase plug 106w may be co-planar. For example, the first-phase plug 106u, the second-phase plug 106v, and/or the third-phase plug 106w may be co-planar in the upright plane. The first-phase plug 106u, second-phase plug 106v, and third-phase plug 106w may be aligned in a row. The second-phase plug 106v may be disposed between the first-phase plug 106u and the third-phase plug 106w. The first-phase plug 106u, second-phase plug 106v, and third-phase plug 106w may each include a same length. Thus, the base 122, prongs 124, and/or conductive lips 126 of each of the first-phase plug 106u, the second-phase plug 106v, and/or the third-phase plug 106w may be co-planar. Although the plugs 106 are described as being co-planar, this is not intended as a limitation of the present disclosure. It is further contemplated that the one or more of the plugs 106 may be in offset planes.

The busbar 104 may receive current from the junction box 102. For example, the busbar 104 may receive current from the plugs 106. The busbar 104 may receive one or more phases of current. In embodiments, the busbar 104 may receive three phases of current, including first-phase (u), second-phase (v), and third-phase (w). The busbar 104 may include sockets 112, bus pins 114, neutral bus 116, and/or molding 118.

The sockets 112 may be rigid elements for engagement with the plugs 106. The busbar 104 may include any number of the sockets 112. In embodiments, the busbar 104 may include three of the sockets 112. For example, the busbar 104 may include a first-phase socket 112u, a second-phase socket 112v, and a third-phase socket 112w. The sockets 112 may each carry a respective phase of electricity. For example, the first-phase socket 112u, second-phase socket 112v, and third-phase socket 112w may carry the first-phase, the second-phase, and the third-phase of electricity, respectively.

The sockets 112 may include a center portion 120 and side portions 130. The sockets 112 may define one or more through holes 132. The through holes 132 may be disposed between the center portion 120 and the side portions 130. Each of the first-phase socket 112u, second-phase socket 112v, and third-phase socket 112w may include the center portion 120, the side portions 130, and the through holes 132.

The sockets 112 may define a female buckle geometry. For example, the sockets 112 may define a female side-release buckle geometry. The center portion 120, the side portions 130, and through holes 132 may collectively define the female side-release buckle geometry.

The side portions 130 may be a pair of the side portions 130 and a pair of through holes 132. For example, the sockets 112 may include a first side portion 130a and a second side portion 130b. The center portion 120 may be disposed between the first side portion 130a and second side portion 130b.

The through holes 132 may be a pair of through holes. For example, the sockets 112 may define a first through hole 132a and a second through hole 132b. The first side portion 130a and center portion 120 may define the first through hole 132a. The second side portion 130b and center portion 120 may define the second through hole 132b. The first through hole 132a may be disposed between the first side portion 130a and center portion 120. The second through hole 132b may be disposed between the second side portion 130b and the center portion 120. The first side portion 130a may be adjacent to the second side portion 130b. Similarly, the first through hole 132a may be adjacent to the second through hole 132b.

In embodiments, the center portion 120, the side portions 130, and/or the through holes 132 may include a selected cross-section. For example, the center portion 120, the side portions 130, and/or the through holes 132 may include a rectangular cross-section. The rectangular cross-section may be along the length of the center portion 120, the side portions 130, and/or the through holes 132. The rectangular cross-sections of the center portion 120, the rectangular cross-section of the side portions 130, and/or the rectangular cross-section of the through holes 132 may include different dimensions. The rectangular cross-sections may or may not be square cross-sections.

The junction box 102 may be connected to the busbar 104. The plugs 106 may connect with the sockets 112 to establish the electrical connection. For example, the plugs 106 of the junction box 102 may be connected to the sockets 112 of the busbar 104. For instance, the first-phase plug 106u, second-phase plug 106v, and third-phase plug 106w may be connected to the first-phase socket 112u, second-phase socket 112v, and third-phase socket 112w, respectively. The busbar 104 may receive the current from the plugs 106. For example, the busbar 104 may receive the three phases of current from the junction box 102. For instance, the first-phase socket 112u, second-phase socket 112v, and third-phase socket 112w may receive the first-phase from the first-phase plug 106u, the second-phase from the second-phase plugs 106v, and the third-phase from the third-phase plugs 106w, respectively. The electrical connector 100 may be a coupling device having the plugs 106 and the sockets 112 which may be adapted for repeated physical engagement or disengagement for establishing and breaking the electrical connection. In embodiments, the plugs 106 may be a threadless joining element. In this regard, the plugs 106 may not include a thread. In this regard, the junction box 102 may be joined to the busbar 104 without using a threaded connection.

The prongs 124 may be configured to join the junction box 102 and busbar 104. The prongs 124 may join the plugs 106 of the junction box 102 to the sockets 112 of the busbar 104 when the plugs 106 are disposed in the sockets 112. The prongs 124 may be disposed in the through holes 132 when the plugs 106 are engaged with the sockets 112. For example, the first prong 124a may be disposed in the first through hole 132a and the second prong 124b may be disposed in the second through hole 132b. The prongs 124 may abut the side portions 130. The prongs 124 may exert pressure on the plugs 106 and the sockets 112. The pressure exerted by the prongs 124 may prevent separation of the plugs 106 from the sockets 112. The abutment between the prongs 124 and the side portions 130 may also serve as an electrical contact area for conducting the electricity. The prongs 124 may be resilient and may exert an outwards force on the side portions 130. The outward force may clamp the plugs 106 to the sockets 112, thereby joining the junction box 102 to the busbar 104. Thus, the busbar 104 may be prevented from sliding in any direction with respect to the junction box 102. The side portions 130 may have a high enough resistance to deformation such that the outwards force from the prongs 124 induces contact between the prongs 124 and side portions 130, without plastic deformation of the side portions 130. The abutment between the prongs 124 and the side portions 130 may also serve as an electrical contact area for conducting the electricity. Thus, the prongs 124 may ensure electrical conductivity and prevent the plugs 106 from disconnecting from the sockets 112 during normal operation of the electrical connector 100.

The conductive lips 126 may abut the side portions 130. For example, the first conductive lip 126a may abut the first side portion 130a and the second conductive lip 126b may abut the second side portion 130b. The abutment between the conductive lips 126 and the side portions 130 may prevent the plugs 106 from disengaging with the sockets 112. Thus, the conductive lips 126 may prevent the junction box 102 from translating relative to the busbar 104 when the plugs 106 are coupled to the sockets 112. The abutment between the conductive lips 126 and the side portions 130 may also serve as an electrical contact area for conducting the electricity. The conductive lips 126 may also cause the prongs 124 to translate inwards as the prongs 124 are inserted into the through holes 132.

The molding 118 may include molded lips 134. For example, the molding 118 may include a pair of the molded lips 134. For instance, the molding 118 may include a first molded lip 134a and a second molded lip 134b. The molding 118 may include the molded lips 134 for each of the sockets 112. The molded lips 134 may be disposed above the side portions 130. For example, the first molded lip 134a may be disposed above the first side portion 130a and the second molded lip 134b may be disposed above the second side portion 130b. The molded lips 134 may be a lock geometry for retaining the plugs 106. For example, the conductive lips 126 may abut both the side portions 130 and the molded lips 134. For instance, the first conductive lip 126a may abut the first side portion 130a and the first molded lip 134a and the second conductive lip 126b may abut the second side portion 130b and the second molded lip 134b. A first side of the conductive lips 126 may abut the conductive lips 126 and a second side of the conductive lips 126 opposed to the first side may abut the molded lips 134. For example, a first side of the first conductive lip 126a and the second conductive lip 126b may abut the first conductive lip 126a and the second conductive lip 126b, respectively, and a second side of the first conductive lip 126a and the second conductive lip 126b opposed to the first side may abut the first molded lip 134a and the second molded lip 134b, respectively. Thus, the conductive lips 126 may be disposed between the side portions 130 and the molded lips 134. For example, the first conductive lip 126a may be disposed between the first side portion 130a and the first molded lip 134a and the second conductive lip 126b may be disposed between the second side portion 130b and the second molded lip 134b. Thus, the plugs 106 may include a lock geometry that prevents the plugs 106 from sliding in the axial direction.

The molding 118 may include tabs 136. For example, the molding 118 may include a pair of the tabs 136. For instance, the molding 118 may include a first tab 136a and a second tab 136b. The molding 118 may include the tabs 136 for each of the sockets 112. The tabs 136 may be disposed below the side portions 130. For example, the first tab 136a may be disposed below the first side portion 130a and the second tab 136b may be disposed below the second side portion 130b. The tabs 136 may align the plugs 106 with the sockets 112 when inserting the plugs 106 in the sockets 112. The tabs 136 may also assist in maintain the connection between the plugs 106 and the sockets 112. For example, the tabs 136 may abut the base 122.

The center portion 120 may be disposed in the center notch 128. For example, the center portion 120 may be disposed in the center notch 128 when the plugs 106 are engaged with the sockets 112. Airgaps 138 may be defined between the prongs 124 and the center portion 120 when the junction box 102 is connected to the busbar 104. For example, a first airgap 138a may be defined between the first prong 124a and the center portion 120 and a second airgap 138b may be defined between the second prong 124b and the center portion 120. The airgaps 138 may permits pinching the prongs 124 together towards the center portion 120. The prongs 124 may be pinched together towards the center portion 120 until the conductive lips 126 no longer abut the side portions 130 and the molded lips 134. The prongs 124 may flex inwards causing the conductive lips 126 to be aligned with the through holes 132. The plugs 106 may be free to translate axially relative to the sockets 112 when the conductive lips 126 no longer abut the side portions 130 and the molded lips 134. Thus, the plugs 106 may be removed from the sockets 112 by pinching the prongs 124 inwards towards the center portion 120. For example, the plugs 106 may be removed from the sockets 112 by pinching the first prong 124a and the second prong 124b together within the first airgap 138a and the second airgap 138b, respectively.

The bus pins 114 may be connected to the sockets 112. For example, the bus pins 114 may be connected to the sockets 112 via one or more internal traces within the busbar 104. The bus pins 114 may be connected to the sockets 112 such that each of the bus pins 114 is associated with a respective phase of electricity. For example, the bus pins 114 may include first-phase bus pins 114u, second-phase bus pins 114v, and third-phase bus pins 114w. The first-phase bus pins 114u may be connected to the first-phase sockets 112u, the second-phase bus pins 114v may be connected to the second-phase sockets 112v, and the third-phase bus pins 114w may be connected to the third-phase sockets 112w, respectively. The bus pins 114 may be rigid elements for engagement with one or more hairpin windings.

The plugs 106 and sockets 112 may be formed from an electrical conductor. For example, the plugs 106 and sockets 112 may be formed from copper, aluminum, or an alloy thereof. The plugs 106 and sockets 112 may form an electrical connection when the plugs 106 contacts the sockets 112. The plugs 106 and sockets 112 may be formed using metal sheet forming, stamping, or the like. In embodiments, the plugs 106 and sockets 112 may include a flat metal plate. For example, the plugs 106 and sockets 112 may each have a thickness which may be much smaller than the width and length. The length of the sockets 112 may be orthogonal to the length of the plugs 106.

The molding 108 and the molding 118 may be formed from an electrical insulator. For example, the molding 108 and the molding 118 may be formed from a plastic material.

The prongs 124 may be advantageous to provide ease-of-assembly when coupling and uncoupling the plugs 106 and sockets 112. The plugs 106 may be coupled and/or uncoupled when external force is applied pinching the prongs 124 together. It is contemplated that the prongs 124 may maintain pressure between the plugs 106 and the sockets 112 with repeated assembly and disassembly of the electrical connector 100. For example, the prongs 124 may maintain pressure between the plugs 106 and the sockets 112 with repeated assembly and disassembly for as long as the prongs 124 are not plastically deformed.

In embodiments, the junction box 102 and the busbar 104 may include an equal number of the plugs 106 and the sockets 112. In this regard, each of the plugs 106 corresponds to a respective of the sockets 112. The busbar 104 may include three of the sockets 112. Similarly, the busbar 104 may include a first-phase socket 112u, a second-phase socket 112v, and a third-phase socket 112w. The first-phase socket 112u, second-phase socket 112v, and third-phase socket 112w may be aligned in a row. The second-phase socket 112v may be disposed between the first-phase socket 112u and the third-phase socket 112w. The first-phase socket 112u, second-phase socket 112v, and third-phase socket 112w may receive the first-phase plug 106u, second-phase plug 106v, and third-phase plug 106w, respectively. Although the electrical connector 100 is described as including three of the plugs 106 and three of the sockets 112, this is not intended as a limitation of the present disclosure. It is contemplated that the electrical connector 100 may include variations on the number of the plugs 106 and the sockets 112. The benefits provided by the prongs 124 may apply to such variable numbers of the plugs 106 and the sockets 112.

In embodiments, the electrical connector 100 may be a high-voltage electrical connector. For example, the electrical connector 100 may be rated to carry over 1,000 VAC. Although the electrical connector 100 is described as a high voltage electrical connector, this is not intended as a limitation of the present disclosure. In embodiments, the electrical connector 100 may be a low voltage electrical connector. The benefits provided by the electrical connector 100 may apply to both low-voltage and high-voltage connectors.

In embodiments, the electrical connector 100 is used for an electrical machine. The electrical machine may include any electrical machine known in the art. It is contemplated that the electrical connector 100 may be used in any electrical machine with the junction box 102 and busbar 104. For example, the electrical machine may include an electric motor. The electric motor may be a three-phase electric motor. The electric motor may be used as a traction drive in a vehicle drive system. Thus, the electrical connector may be a high-voltage connector for a three-phase electrical machine.

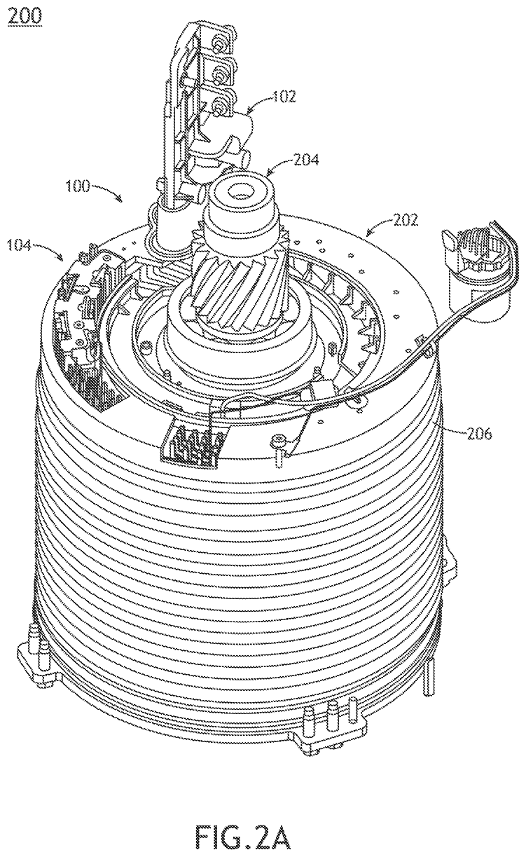

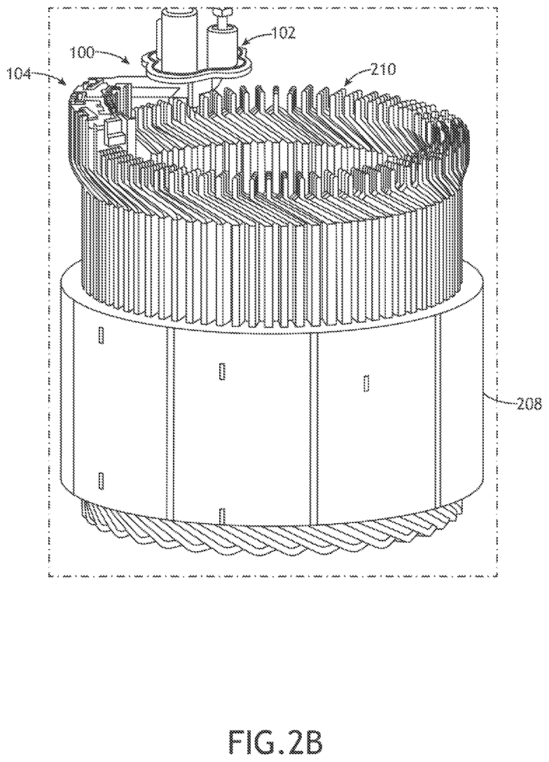

FIGS. 2A-2B illustrates an electric motor 200, in accordance with one or more embodiments of the present disclosure. The electric motor 200 may be a three-phase electric motor. The three-phase electric motor may carry the respective phases received by the junction box 102. The electric motor 200 may include the electrical connector 100, a stator 202, and/or a rotor 204.

The bus pins 114 may engagement with the stator 202. The busbar 104 may distribute the three phases of current to the stator 202. For example, the bus pins 114 may be connected to the stator 202 for distributing the three phases of current. The stator 202 may receive the current from the busbar 104. The stator 202 may induce a magnetic field in response to receiving the three phases of current from the busbar 104.

The rotor 204 may be disposed within a central axis of the stator 202. The rotor 204 may be supported by the stator 202 via one nor more bearings. The magnetic field induced by the stator 202 may cause the rotor 204 to rotate relative to the stator 202. The rotor 204 may perform work on one or more external components via the rotation of the rotor 204. Thus, the electric motor 200 may be a dynamo-electric machine which converts electrical energy to mechanical energy by electromagnetic means.

The stator 202 may include one or more of a stator carrier 206, a stator core 208, a winding 210, and the like. The stator carrier 206 may be a housing for the components of the stator 202. The stator carrier 206 may encapsulate the stator core 208, the winding 210, and the like. The stator core 208 may be made of stacks of one or more stacks of lamination. The stator core 208 may define one or more slots for the winding 210. The winding 210 of the stator 202 may disposed in the slots of the stator core.

The winding 210 may be connected to the busbar 104. The winding 210 may receive the current from the busbar 104 and induce the magnetic field. The winding 210 may include any suitable type of winding, such as, but not limited to, a hairpin winding (e.g., a hairpin lap winding) or the like. The winding 210 may be made of a plurality of hairpins. The hairpins may be joined together to form the winding 210. For example, the hairpins may be joined together by a weld (e.g., a laser weld), cap, or the like to form the winding 210. The hairpins may be flat bars which may be bent into a select shape. For example, the hairpins may include a “U-shape” or the like.

The winding 210 may be a three-phase winding including the first-phase (u), the second-phase (v), and the third-phase (w). The winding 210 may include poles which alternate in sequence between the first-phase (u), the second-phase (v), and the third-phase (w). The hairpins may carry a respective of the phases to define the poles. For example, the hairpins may include first-phase hairpins, second-phase hairpins, and third-phase hairpins. The first-phase hairpins, second-phase hairpins, and third-phase hairpins may similarly be arranged in the alternating arrangement. The first-phase hairpins, second-phase hairpins, and third-phase hairpins may be connected to the first-phase bus pins 114u, the second-phase bus pins 114v, and the third-phase bus pins 114w, respectively. Thus, the hairpins of the winding 210 may connect to the bus pins 114 of the busbar 104. The connection between the winding 210 and the bus pins 114 may be referred to as a pin/pin connection.

The winding 210 may be coupled to the neutral bus 116. The first-phase hairpins, second-phase hairpins, and third-phase hairpins of the winding 210 may be connected to the neutral bus 116. The connection between the winding 210 and the neutral bus 116 may be referred to as a pin/neutral connection.

Current distribution to the electric motor 200 may be achieved through the electrical connector 100. Internally the junction box 102 connects and distributes the current for the stator 202 through the busbar 104. The busbar 104 distributes the current at the stator 202 to generate the magnetic field and produce the rotor movement. The busbar 104 may distribute current for the winding 210. For example, the busbar 104 may distribute each of the phases of current to the winding 210. The winding 210 may be a “wye” transformer by being connected at a first end to the first-phase bus pins 114u, the second-phase bus pins 114v, and the third-phase bus pins 114w, respectively, and by being connected at a second end to the neutral bus 116. The neutral bus 116 is a common neutral between each of the phases. The neutral bus 116 may or may not be connected to a ground.

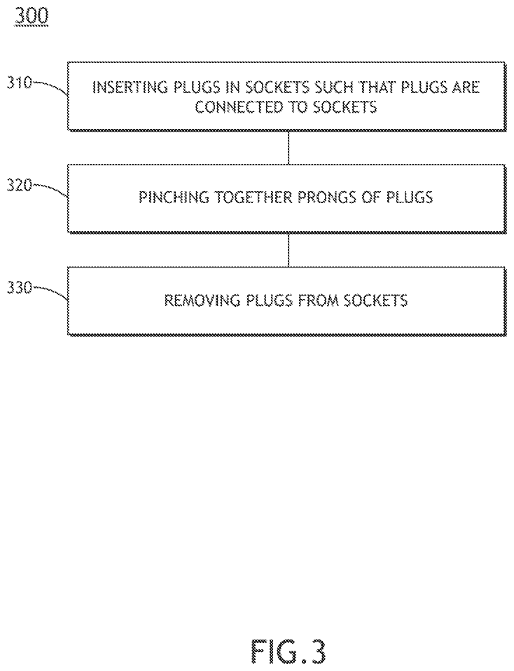

FIG. 3 illustrates a flow diagram of a method 300 of securing a plug and socket of an electrical connector of an electrical machine, in accordance with one or more embodiments of the present disclosure. The method 300 provides a means for electrically coupling and uncoupling the electrical connector 100. The embodiments and the enabling technology described previously herein in the context of the electrical connector 100 should be interpreted to extend to the method 300. It is further recognized, however, that the method is not limited to the electrical connector 100.

In a step 310, plugs of a junction box may be inserted into sockets of a busbar such that the plugs are connected to the sockets. For examples, the plugs 106 may be inserted in the sockets 112 such that the plugs 106 are connected to the sockets 112. For instance, the first-phase plug 106u, second-phase plug 106v, and the third-phase plug 106w may be inserted in the first-phase socket 112u, second-phase socket 112v, and third-phase socket 112w, respectively. Inserting may include translating the plugs 106 relative to the sockets 112. For example, the busbar 104 may be fixed while inserting the plugs 106 of the junction box 102 into the sockets 112.

In a step 320, the prongs of the plugs may be pinched together. For example, the prongs 124 of the plugs 106 may be pinched together. For instance, the prongs 124 of the plugs 106 may be pinched together within the airgap 138 defined between the prongs 124 and the center portion 120. The first prong 124a and the second prong 124b may be pinched together. For example, the first prong 124a and the second prong 124b may be pinched together within the first airgap 138a and the second airgap 138b, respectively. The prongs 124 of the plugs 106 may be pinched together such that the conductive lips 126 do not abut the side portions 130 and are aligned with the through holes 132. For instance, the first prong 124a and the second prong 124b may be pinched together the first conductive lip 126a does not abut the first side portion 130a and is aligned with the first through hole 132a and such that the second conductive lip 126b does not abut the second side portion 130b and is aligned with the second through hole 132b.

In a step 330, the plugs of the electrical connector may be removed from the sockets of the electrical connector. For example, the plugs 106 may be removed from the sockets 112 such that the plugs 106 and the sockets 112 are not in electrical contact. The plugs 106 may be removed by translating the plugs 106 relative to the sockets 112. For example, the prongs 124 may be removed from the through holes 132. The first-phase plug 106u, second-phase plug 106v, and the third-phase plug 106w may be removed from the first-phase socket 112u, second-phase socket 112v, and third-phase socket 112w, respectively.

Referring generally again to the figures. Although much of the present disclosure has described the junction box 102 as including the plugs 106 and the busbar 104 as including the sockets 112, this is not intended as a limitation of the present disclosure. It is contemplated that the junction box 102 may include the sockets 112 and the busbar 104 may include the plugs 106. However, the junction box 102 including the plugs 106 may be desirable to improve ease-of-assembly of the electrical connector 100.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for applications.

### LIST OF REFERENCE NUMBERS

100 electrical connector
102 junction box
104 busbar
106 plugs
106u first-phase plug
106v second-phase plug
106w third-phase plug
108 molding
110 bars
110u first-phase bar
110v second-phase bar
110w third-phase bar
112 sockets
112u first-phase socket
112v second-phase socket
112w third-phase socket
114 bus pins
114u first-phase bus pins
114v second-phase bus pins
114w third-phase bus pins
116 neutral bus
118 molding
120 center portion
122 base
124 prongs
124a first prong
124b second prong
126 conductive lips
126a first conductive lip
126b second conductive lip
128 center notch
130 side portions
130a first side portion
130b second side portion
132 through holes
132a first through hole
132b second through hole
134 molded lips
134a first molded lip
134b second molded lip
136 tabs
136a first tab
136b second tab
138 airgaps
138a first airgap
138b second airgap
200 electric motor
202 stator
204 rotor
206 stator carrier
208 stator core
210 winding

What is claimed:

1. An electrical connector comprising:
a junction box comprising a plurality of plugs comprising a base, a first prong, a second prong, a first conductive lip and a second conductive lip, wherein the first prong and the second prong extend from the base, wherein the first conductive lip extends from the first prong, wherein the second conductive lip extends from the second prong, wherein the first prong and the second prong are disposed between the first conductive lip and the second conductive lip; and
a busbar comprising a plurality of sockets comprising a center portion, a first side portion, and a second side portion, wherein the center portion is disposed between the first side portion and the second side portion, wherein the first side portion and the center portion define a first through hole, wherein the second side portion and the center portion define a second through hole;
wherein the plurality of plugs are connected to the plurality of sockets, wherein the first prong is disposed in the first through hole and the second prong is disposed in the second through hole, wherein the first conductive lip abuts the first side portion and the second conductive lip abuts the second side portion.

2. The electrical connector of claim 1, wherein the plurality of plugs are a first-phase plug, a second-phase plug, and a third-phase plug, wherein the plurality of sockets are a first-phase socket, a second-phase socket, and a third-phase socket, wherein the first-phase plug, the second-phase plug, and the third-phase plug are connected to the first-phase socket, the second-phase socket, and the third-phase socket, respectively.

3. The electrical connector of claim 1, wherein the first prong abuts the first side portion, wherein the second prong abuts the second side portion.

4. The electrical connector of claim 3, wherein the base, the first prong, and the second prong define a center notch, wherein the center notch is disposed between the first prong and the second prong, wherein the center portion is disposed in the center notch.

5. The electrical connector of claim 4, wherein a first airgap is defined between the first prong and the center portion and a second airgap is defined between the second prong and the center portion.

6. The electrical connector of claim 5, wherein the plurality of plugs are configured to be removed from the plurality of sockets by pinching the first prong and the second prong together within the first airgap and the second airgap, respectively.

7. The electrical connector of claim 1, wherein the base, the first prong, the second prong, the first conductive lip, and the second conductive lip are co-planar.

8. The electrical connector of claim 7, wherein each of the plurality of plugs are co-planar.

9. The electrical connector of claim 1, wherein the center portion, the first side portion, the second side portion, the first through hole, and the second through hole comprise a rectangular cross-section.

10. The electrical connector of claim 1, the busbar comprising a molding comprising a first molded lip and a second molded lip for each of the plurality of sockets, wherein the first conductive lip abuts the first molded lip and the second conductive lip abuts the second molded lip.

11. The electrical connector of claim 10, wherein the first conductive lip is disposed between the first side portion and the first molded lip and the second conductive lip is disposed between the second side portion and the second molded lip.

12. The electrical connector of claim 1, the busbar comprising a molding comprising a first tab and a second tab for each of the plurality of sockets, wherein the first tab is disposed below the first side portion and the second tab is disposed below the second side portion.

13. The electrical connector of claim 12, wherein the first tab and the second tab abut the base.

14. The electrical connector of claim 1, the busbar comprising a plurality of bus pins connected to the plurality of sockets.

15. An electric motor comprising:
an electrical connection comprising:
a junction box comprising a plurality of plugs comprising a base, a first prong, a second prong, a first conductive lip and a second conductive lip, wherein the first prong and the second prong extend from the base, wherein the first conductive lip extends from the first prong, wherein the second conductive lip extends from the second prong, wherein the first prong and the second prong are disposed between the first conductive lip and the second conductive lip; and
a busbar comprising a plurality of sockets comprising a center portion, a first side portion, and a second side portion, wherein the center portion is disposed between the first side portion and the second side portion, wherein the first side portion and the center portion define a first through hole, wherein the second side portion and the center portion define a second through hole;
wherein the plurality of plugs are connected to the plurality of sockets, wherein the first prong is disposed in the first through hole and the second prong is disposed in the second through hole, wherein the first conductive lip abuts the first side portion and the second conductive lip abuts the second side portion;
a stator comprising a stator core and a winding; wherein the winding is connected to the busbar; and
a rotor.

16. The electric motor of claim 15, wherein the electric motor is a three-phase electric motor, wherein the plurality of plugs are a first-phase plug, a second-phase plug, and a third-phase plug, wherein the plurality of sockets are a first-phase socket, a second-phase socket, and a third-phase socket, wherein the first-phase plug, the second-phase plug, and the third-phase plug are connected to the first-phase socket, the second-phase socket, and the third-phase socket, respectively.

17. The electric motor of claim 16, the busbar comprising a plurality of bus pins and a neutral bus, wherein the plurality of bus pins are connected to the plurality of sockets, wherein the winding is connected to the plurality of bus pins and the neutral bus, wherein the plurality of bus pins comprise one or more first-phase bus pins, one or more second-phase bus pins, and one or more third-phase bus pins.

18. The electric motor of claim 17, wherein the winding is a hairpin winding.

19. A method comprising:
inserting a plurality of plugs of a junction box into a plurality of sockets of a busbar such that the plurality of plugs are connected to the plurality of sockets, wherein the plurality of plugs comprise a base, a first prong, a second prong, a first conductive lip and a second conductive lip, wherein the first prong and the second prong extend from the base, wherein the first conductive lip extends from the first prong, wherein the second conductive lip extends from the second prong, wherein the first prong and the second prong are disposed between the first conductive lip and the second conductive lip, wherein the plurality of sockets comprise a center portion, a first side portion, and a second side portion, wherein the center portion is disposed between the first side portion and the second side portion, wherein the first side portion and the center portion define a first through hole, wherein the second side portion and the center portion define a second through hole, wherein the first prong is disposed in the first through hole and the second prong is disposed in the second through hole, wherein the first conductive lip abuts the first side portion and the second conductive lip abuts the second side portion.

20. The method of claim 19, comprising:
pinching together the first prong and the second prong such that the first conductive lip does not abut the first side portion and is aligned with the first through hole and such that the second conductive lip does not abut the second side portion and is aligned with the second through hole; and
removing the plurality of plugs from the plurality of sockets.
